(19) United States
(12) Patent Application Publication
(10) Pub. No.: US 2023/0264188 A1
(43) Pub. Date: Aug. 24, 2023

(54) DECANTING KIT FOR ENABLING EASY SEPARATION AND EXTRACTION OF COMPONENTS

(71) Applicant: MIRACELL CO., LTD., Seoul (KR)

(72) Inventor: Hyun Sun SHIN, Seoul (KR)

(21) Appl. No.: 18/020,580

(22) PCT Filed: Jan. 25, 2021
(86) PCT No.: PCT/KR2021/000951

§ 371 Date: Feb. 9, 2023

(51) Int. Cl. B01L 3/00

(52) U.S. Cl. CPC B01L 3/5021; B01L 2400/0409; B01L 2300/048

(57) ABSTRACT

A decanting kit for enabling easy separation and extraction for each component comprises: a centrifugal separation container configured to concentrate and separate a sample placed inside for each component according to a density difference during centrifugal separation using a centrifugal separation; a decanting container connected and mounted on an upper part of the centrifugal separation container and configured to decant components separated from the centrifugal separation container while being inclined at a predetermined slope; a floater provided within the centrifugal separation container, configured to move along the longitudinal direction of the centrifugal separation container, and disposed at a boundary of the centrifugally separated components according to a density difference of the centrifugally separated sample for each component; and an insert cover mounted within the centrifugal separation container and configured to limit a movement distance of the floater moving along the longitudinal direction of the centrifugal separation container.

### TECHNICAL FIELD

The present disclosure relates to a decanting kit for enabling easy separation and extraction for each component, and more particular, to a decanting kit for enabling easy separation and extraction for each component, which can facilitate selective extraction of certain components concentrated and separated according to a density difference in the separation of blood components using a centrifugal separator.

### BACKGROUND ART

When a suspension with a floating material remains still, a high-density material gradually sinks to the bottom by the influence of gravity, and a low-density material gradually moves to an upper layer. Such a process refers to a sediment.

As described above, when the materials with different densities are mixed, a sediment phenomenon occurs, and the mixture may be separated according to the density difference over time. Said differently, since the stronger gravity, which is a force to separate the mixture, allows the larger density difference between the mixtures, the artificial increase in the gravity may accelerate the sediment phenomenon.

Accordingly, when a centrifugal force is used instead of gravity, the sediment phenomenon can be easily accelerated. This process refers to “centrifugation”. The pertinent centrifugal separator is an instrument used to separate, purify and concentrate components or materials with different densities by using the aforementioned centrifugal separation principle, which may be classified into a medical instrument, a wastewater-treating instrument, a uranium concentration instrument, an instrument for production, and an experimental instrument according to the intended use.

Among them, a medical centrifugal separator is used to separate components for a blood, urine or salvia analysis, as well as to extract platelet-rich plasma (PRP). Herein, the PRP can be obtained by the centrifugal separation of a complex fluid (hereinafter referred to as “a sample”) such as bone marrow or blood, and means a high-enrichment blood plasma component that has larger platelets than general bone marrow or blood. In other words, since the PRP contains a variety of growth factors, it serves to heal wounds and regenerate wounded parts. For instance, the PRP can be injected into the wound parts of ligaments and/or cartilages so as to regenerate the wounded parts. Furthermore, since the PRP uses a patient's own bone marrow or blood, it does not have side effects and provides a quick treatment effect.

Meanwhile, the aforementioned centrifugal separator is divided into various types according to the amount and the rotation speed of the sample targeted for the centrifugal separator and the kinds of rotors, and includes a centrifugal separation container configured to separate and recover the components of the sample by a centrifugal force of the rotor's rotational movement.

Based on such a technical idea, Korean Publication Unexamined Patent Application No. 10-2007-0026316 describes a disposable container for centrifugally separating and treating fluid biological materials. However, in the selective extraction of certain components from the centrifugally separated components in the container, since the centrifugally separated components form multiple layers in one chamber within the container based on the process of fixing an injection needle into a third canola (i.e., a hose) simply configured to extend from the cover to the bottom of the container and inhale and extract the components, the centrifugally separated components may be mixed again due to the content change in the sample during the inhale and extraction (or the inhale) with a syringe. Accordingly, since the components may be only extracted in the mixed state, there is a limit to full extraction of only certain components.

In addition, since an adhesive is used to couple the cover to the container, the centrifugal container is not easy to assemble and produce. Furthermore, since an injection port and an extraction port of the sample are only formed of a rubber material, the components obtained by injecting or separating the sample may not be easily separated and extracted in the state where the injection needle is fixed into an exact position.

### DETAILED DESCRIPTION OF THE INVENTION

### Technical Problem

The present discourse is to solve the aforementioned problems, and aspects of the present disclosure provide a decanting kit for enabling easy separation and extraction for each component, which can fully, easily and rapidly extract certain components from separated components simultaneously with exactly separating the components using different density for each component, in the separation of the sample with the density difference for each component and the centrifugal force according to the rotation of a rotor by driving a centrifugal separator.

Aspects of the present disclosure also provide a decanting kit for enabling easy separation and extraction for each component, which can considerably improve the work efficiency of extracting certain components through a centrifugal separation of a sample according to easy storage in addition to concentration and separation of the sample for each component and selective extraction and recovery, by forming, in a structure capable of mutual disassembly and assembly, a component recovery container where the certain components with low density are separated and stored among components concentrated and separated from a centrifugal separation container for concentration and separation for each components of the sample.

### Solution to Problem

According to an aspect of the present disclosure, there is provided a decanting kit for enabling easy separation and extraction for each component, comprising: a centrifugal separation container configured to concentrate and separate a sample placed therein for each component according to a density difference during centrifugal separation using a centrifugal separator; a decanting container connected and mounted on an upper part of the centrifugal separation container and configured to decant components separated from the centrifugal separation container while being inclined at a predetermined slope; a floater provided within the centrifugal separation container, configured to move along the longitudinal direction of the centrifugal separation container, and disposed at a boundary of the centrifugally separated components according to a density difference of the centrifugally separated sample for each component; and an insert cover mounted within the centrifugal separation container and configured to limit a movement distance of the floater moving along the longitudinal direction of the centrifugal separation container.

According to the present disclosure, the centrifugal separation container comprises: a centrifugal separation container body configured to store the sample targeted for centrifugal separation by a predetermined amount and having a centrifugal separation chamber formed therein to concentrate and separate the sample for each component during the centrifugal separation; a centrifugal separation container cover configured to seal an upper end of an opening of the centrifugal separation container body and including an injection port configured to inject the sample into the centrifugal separation container, a vent port configured to discharge air during the injection of the sample and a discharge part configured to discharge the centrifugally separated components; and a first packing ring intervened between the centrifugal separation container body and centrifugal separation container cover and equipped with a first packing ring to seal the inside. The centrifugal separation container body comprises: a flange formed outwards from the upper part of the centrifugal separation container body, to which the centrifugal separation container cover is hooked; a ring stepped portion formed within the flange and configured to seal centrifugal separation container cover and the centrifugal separation container body; and a coupling groove formed within the ring stepped portion and configured to form the same inner circumferential surface as the inside of the centrifugal separation container cover. The centrifugal separation container cover comprises: a centrifugal separation container cover body provided with a cover side hooked to an outer circumferential surface of the flange; a ring settling groove formed within the cover side and configured to settle the flange and the first packing ring therein; a coupling stepped portion inserted into the coupling groove and configured to form the same inner circumferential surface as the centrifugal separation container body; a discharge part protruding upwards so that the centrifugally separated sample can form a guide surface having the same the inner circumferential surface as the centrifugal separation container body during a certain section and be simultaneously decanted to the decanting container.

According to the present disclosure, the decanting container comprises: a decanting container body having a decanting chamber formed therein so that the components discharged from the centrifugal separation container are separated, moved and stored; and a decanting container cover configured to seal an upper end of an opening of the decanting container body and provided with a discharge port and a vent port capable of extracting the components from the decanting container body, wherein an inlet having the same guide surface as the discharge part so that low-density components discharged from the discharge part of the centrifugal separation container body can flow is formed on one side of the decanting container body. The discharge part comprises: an upper flange having a certain shape and extending upwards from the (centrifugal separation container) cover body by a predetermined distance; a cover coupling stepped portion extending upwards from the upper flange and having a stepped portion formed therein; and a discharge part having a certain shape and formed within the cover coupling stepped portion. The inlet comprises: an inlet port settled in the cover coupling stepped portion of the discharge part and having the same guide surface as the discharge part; and a coupling hook having a certain shape, configured to surround an outer side of the cover coupling stepped portion and a second packing ring and hooked to the upper flange, and a second packing ring intervened between the outer side of the cover coupling stepped portion and the coupling hook and configured to seal the discharge part and the inlet.

### Effect of the Invention

A decanting kit facilitating separation and extracting for each component according to the present disclosure can more easily achieve a component separation process of a sample and a selective extraction process of certain components because the components of the sample can be concentrated and separated for each component by a centrifugal separation container, and the certain components can be separated and stored using a component recovery container.

In addition, according to the present disclosure, since unnecessary components cannot be included in the extracted components by limiting the movement distance of a floater moving up and down within the centrifugal separation container, only the certain components can be fully extracted.

In addition, according to the present disclosure, desired components can be separated from blood or bone marrow used in an autologous bone marrow treatment and an autologous blood treatment, and medical results can be achieved which increases the treatment effect using the separated components (e.g., the PRP), thereby considerably contributing to the development of the pertinent medical industry

### BRIEF DESCRIPTION OF DRAWINGS

FIG. 1 is a perspective view of a decanting kit for enabling easy separation and extracting for each component according to the present disclosure;

FIG. 2 is an exploded perspective view of a centrifugal separation container of the decanting kit for enabling easy separation and extracting for each component according to the present disclosure;

FIG. 3 is a bottom perspective view of a centrifugal separation container cover according to the present disclosure;

FIG. 4 is an exploded perspective view of a decanting container of the decanting kit for enabling easy separation and extracting for each component according to the present disclosure;

FIG. 5 is a perspective view of the decanting container when viewed from the bottom side thereof according to the present disclosure;

FIG. 6 is a cross-sectional view of the decanting kit for enabling easy separation and extracting for each component according to the present disclosure;

FIG. 7 is an operation view of the decanting kit for enabling easy separation and extracting for each component according to the present disclosure; and

FIGS. 8 and 9 are exemplary views illustrating an operation of a rotor of a centrifugal separator of the decanting kit for enabling easy separation and extracting for each component according to the present disclosure.

### BEST MODES OF THE INVENTION

A decanting kit for enabling easy separation and extraction for each component according to the most preferred embodiment of the present disclosure comprises: a centrifugal separation container configured to concentrate and separate a sample for each component according to a density difference during centrifugal separation using a centrifugal separation; a decanting container connected and mounted on an upper part of the centrifugal separation container and configured to decant components separated from the centrifugal separation container while being inclined at a predetermined slope; a floater provided within the centrifugal separation container, configured to move along the longitudinal direction of the centrifugal separation container, and disposed at a boundary of the centrifugally separated components according to a density difference of the centrifugally separated sample for each component; and an insert cover mounted within the centrifugal separation container and configured to limit a movement distance of the floater moving along the longitudinal direction of the centrifugal separation container.

### Mode for Invention

Hereinafter, preferred embodiments according to the present disclosure are described in detail with reference to the accompanying drawings so that one of ordinary skill in the art to which the invention pertains can easily implement the present disclosure. In denoting reference numerals to constituent elements of the respective drawings, it should be noted that the same constituent elements will be designated by the same reference numerals, if possible, even though the constituent elements are illustrated in different drawings. Further, in the following description, a detailed explanation of known related technologies may be omitted to avoid unnecessarily obscuring the subject matter of the present disclosure.

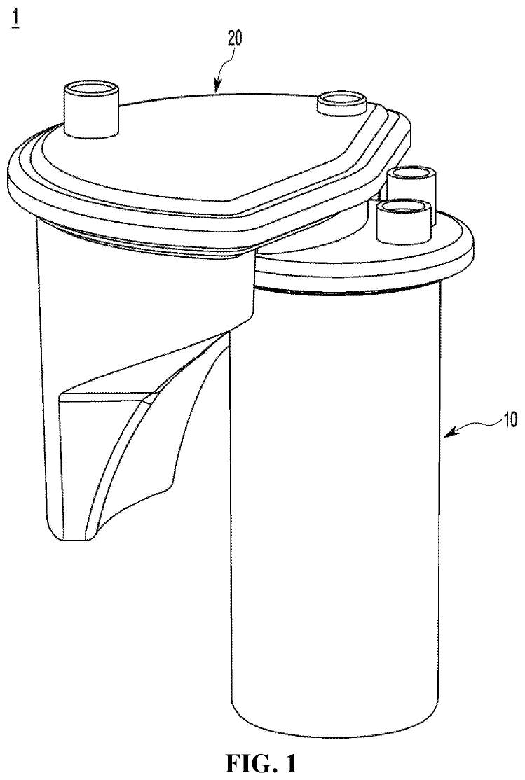

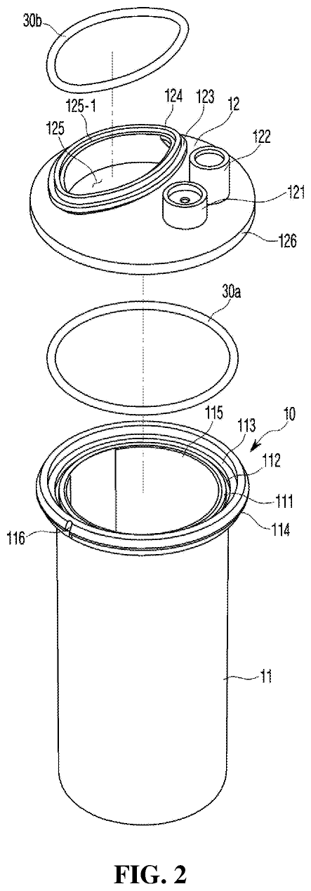

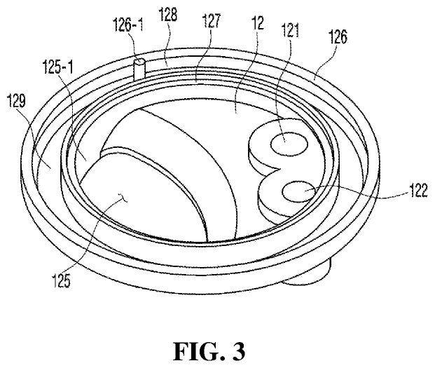

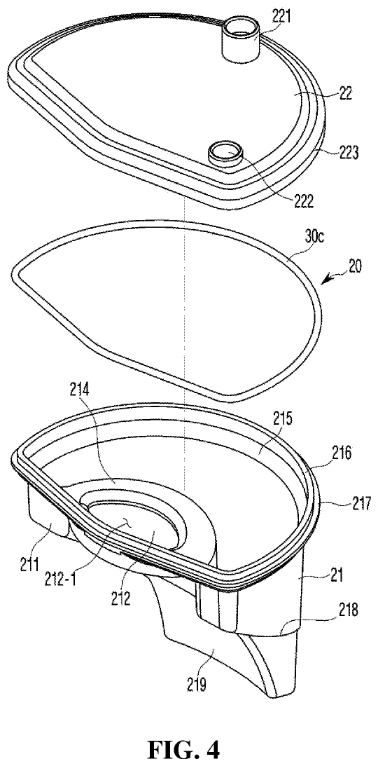

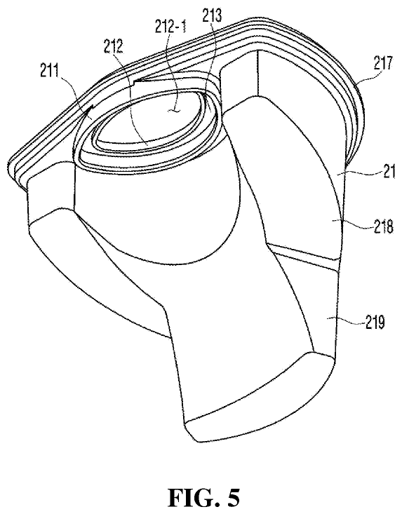

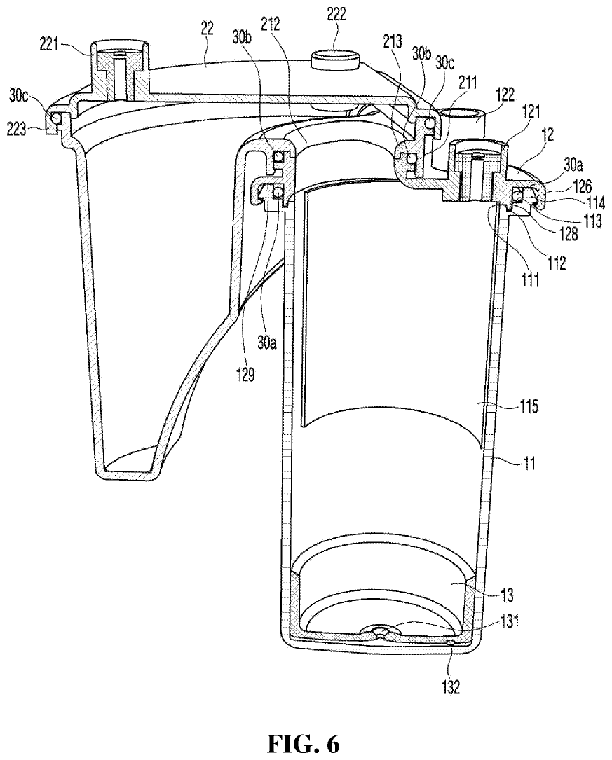

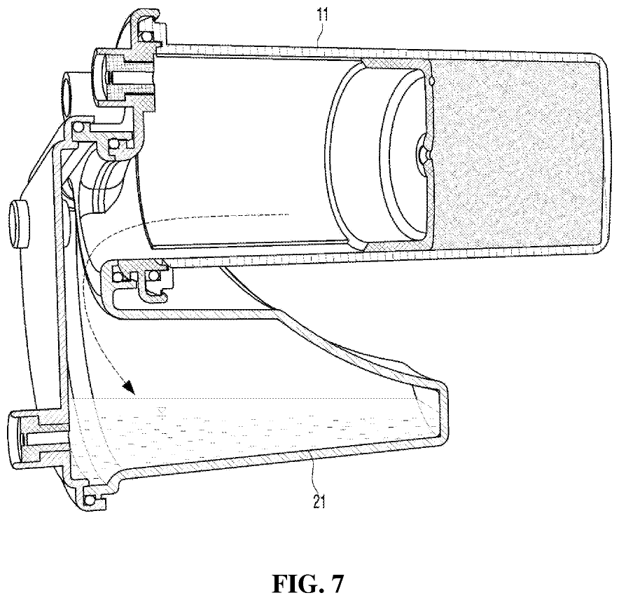

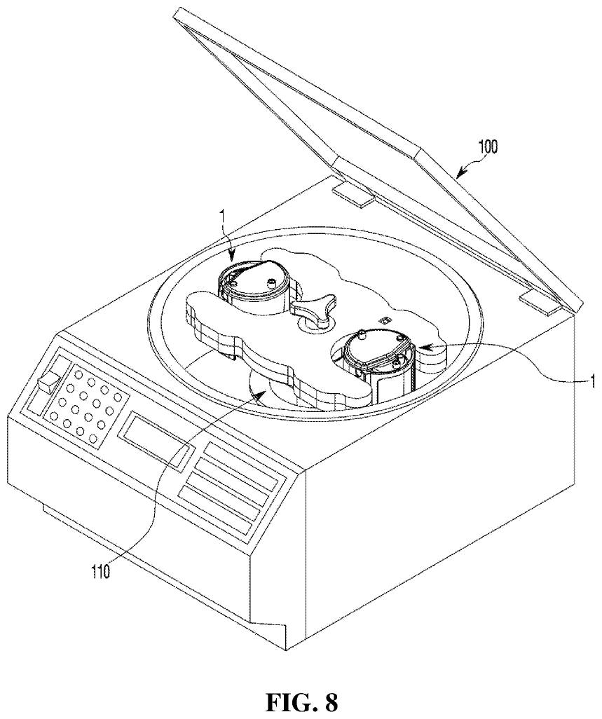

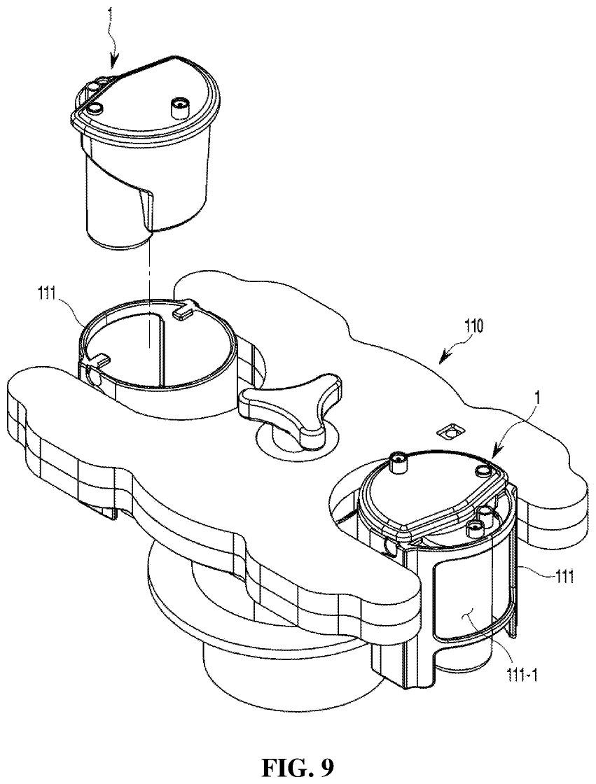

FIG. 1 is a perspective view of a decanting kit for enabling easy separation and extracting for each component according to the present disclosure, FIG. 2 is an exploded perspective view of a centrifugal separation container of the decanting kit for enabling easy separation and extracting for each component according to the present disclosure, FIG. 3 is a bottom perspective view of a centrifugal separation container cover according to the present disclosure, FIG. 4 is an exploded perspective view of a decanting container of the decanting kit for enabling easy separation and extracting for each component according to the present disclosure, FIG. 5 is a perspective view of the decanting container when viewed from the bottom side thereof according to the present disclosure, FIG. 6 is a cross-sectional view of the decanting kit for enabling easy separation and extracting for each component according to the present disclosure, FIG. 7 is an operation view of the decanting kit for enabling easy separation and extracting for each component according to the present disclosure, and FIGS. 8 and 9 are exemplary views illustrating an operation of a rotor of a centrifugal separator of the decanting kit for enabling easy separation and extracting for each component according to the present disclosure.

As illustrated in FIG. 1, a decanting kit 1 for enabling easy separation and extracting for each component according to the present disclosure includes a centrifugal separation container 10 configured to concentrate and separate a sample placed therein for each component according to a density difference during centrifugal separation using a centrifugal separator, and a decanting container 20 connected and mounted on an upper part of the centrifugal separation container and configured to separate and store the components discharged from the centrifugal separation container 10 inclined close to the horizontal direction by a centrifugal force during the centrifugal separation.

Referring to FIG. 8, a centrifugal separator 3 will be described. The centrifugal separator 3 is an instrument used to separate and recover only certain components from a complex fluid (hereinafter referred to as “a sample”), such as the separation of blood cells and plasma from blood or the separation of stem cells from bone marrow. As illustrated in FIGS. 8 and 9, the centrifugal separator 3 is equipped with a rotor 2 that rotates horizontally at the time of driving the instrument and provided with a plurality of buckets 2-1 that rotates along during the rotation of the rotor 2 in the state where the decanting kit 1 is accommodated and mounted.

In addition, as illustrated in FIG. 9, a hole 2-2 through which the decanting kit 1 is seen inside or the load of the rear is reduced is formed on one side of the perimeter of the bucket 2-1.

The decanting kit 1 becomes a storage medium to concentrate and separate the sample for each component and includes a centrifugal separation container body 11 configured to store the sample targeted for centrifugal separation by a predetermined amount and having a centrifugal separation chamber 14 formed therein to concentrate and separate the sample for each component during the centrifugal separation, a centrifugal separation container cover 12 configured to seal an upper end of an opening of the centrifugal separation container body 11 and capable of injecting the sample into the centrifugal separation chamber 14, a floater 13 provided within the centrifugal separation container body 11 and configured to move along the longitudinal direction of the centrifugal separation container body 11 so that it is disposed at boundaries of each of the components according to a density difference of the centrifugally separated sample for each component, and an insert cover 15 mounted in the centrifugal separation chamber 14 within the centrifugal separation container body 11 so as to limit an up and down movement distance of the floater 13.

As illustrated in FIG. 2, the centrifugal separation container 10 includes the centrifugal separation container body 11, a flange 14 formed outwards from the upper part of the centrifugal separation container body 11, to which the centrifugal separation container cover 12 is hooked, a ring stepped portion 113 formed within the flange 114 and equipped with a first packing ring 30a to seal the centrifugal separation container cover 12 and the centrifugal separation container body 11, and a coupling groove 112 formed within the ring stepped portion 113 and configured to form the same inner circumferential surface as the inside of the centrifugal separation container cover 12, and an upper end 111 of the centrifugal separation container body 11 is provided with the coupling groove 112 along with the ring stepped portion 113. Furthermore, a fastening groove 116 configured to fasten the coupling position of the centrifugal separation container cover 12 is formed on one side of the flange 114. The fastening groove 116 may fasten the mounting position of the centrifugal separation container cover 12 while inserting a fastening protrusion 121-2 formed on the centrifugal separation container cover 12.

As illustrated in FIGS. 2 and 3, the centrifugal separation container cover 12 includes a centrifugal separation container cover body 121 provided with a cover side 121-1 hooked to an outer circumferential surface of the flange 114, a ring settling groove 129 formed within the cover side 121-1 and configured to settle the flange 114 and the first packing ring 30a therein, and a coupling stepped portion 127 inserted into the coupling groove 112 and configured to form the same inner circumferential surface as the centrifugal separation container body 11, and a discharge part 125 protruding upwards so that the centrifugally separated components can be decanted to the decanting container by forming the same inner surface as the inner circumferential surface of the centrifugal separation container body 11 during a certain section. The discharge part 125 includes a guide plate 125-1 configured to form the same inner surface as the inner circumferential surface of the centrifugal separation container body 11 during the certain section, a discharge port 125-2 having a certain shape and formed by the guide plate 125-1, an upper flange 125-3 extending upwards from the centrifugal separation container cover body 121 by a predetermined distance, and a cover coupling stepped portion 125-4 extending upwards from the upper flange 125-3 and having a stepped portion formed therein. The guide plate 125-1 forms a flow path so that a centrifugally separated certain sample can easily move to the decanting container 20 by forming the same inner surface as the inner circumferential surface of the centrifugal separation container body 11 during the certain section. The centrifugal separation container cover 12 is provided with an injection port 126 and a vent port 122, and the sample is injected into the centrifugal separation chamber 14 of the centrifugal separation container through the injection port 126. When the sample is injected through the injection port 126, air may be discharged to the outside through vent port 122.

FIGS. 4 and 5 illustrate the decanting container 20. The decanting container 20 includes a decanting container body 21 having a decanting chamber 23 formed therein so that the components discharged from the centrifugal separation container 10 are separated, moved and stored, and a decanting container cover 22 configured to seal an upper end of an opening of the decanting container body 21 and provided with a discharge port 221 and a vent port 222 capable of extracting the components from the decanting container body 21. The decanting container body 21 is provided with a decanting chamber 213 and an inlet 211. The inlet 211 includes an outer guide plate 211-1 hooked to the upper flange 125-3, an inner guide plate 211-2 formed identically to the guide plate 125-1, an inlet coupling groove 211-4 formed by the outer guide plate 211-1 and the inner guide plate 211-2, and an inlet port 211-3 formed by the inner guide plate 211-2. The inner guide plate 211-2 is settled in the cover coupling stepped portion 125-4, and a second packing ring 30b is intervened between an outer surface of the cover coupling stepped portion 125-4 and the outer guide plate 211-1. A berm 214 is formed in a part passing through the inlet port 211-3 and entering the decanting chamber 213 so that the centrifugally separated components can smoothly move to the decanting chamber 213. The decanting chamber 213 is provided with a chamber formed by an inclined surface 218 formed downwards on opposite sides at a predetermined angle and a storage groove 219 configured to store centrifugally separated components passing through the inclined surface 218. An extended section 216 extending upwards by a predetermined length and a decanting flange 217 formed on an outer surface of the extended section 216 are provided in an upper end of the decanting container 21.

The decanting container cover 22 includes a decanting container cover body 221, an outer surface portion 223 extending downwards from the decanting container cover body 221 to form a frame, and an extraction port 222 and a vent port 224 formed in the decanting container cover body 221. The outer surface portion 223 of the decanting container cover body 221 is hooked to the decanting flange 217, and a third packing ring 30c for sealing is intervened between the outer surface portion 223 hooked to the decanting flange 217 and the extended section 216.

The floater 13 is meant to prevent sedimentary components and floating components from being mixed through a boundary between each component of the sample concentrated and separated for each component in the centrifugal separation container body 11. As illustrated in FIG. 6, the floater 13 is configured in the form of a basket or a plate. A plurality of platforms 132 protrude to a lower surface of a bottom plate of the floater 13 so that high-density components can be easily sedimented to a lower side of the centrifugal separation chamber 14 during the centrifugal separation by forming a sufficient gap from the bottom plate of the floater 13 of the centrifugal separation container body 11, and an aperture 131 is formed to penetrate in the center of the bottom plate of the floater 13 so that the high-density components can penetrate and be sedimented on the lower surface of the bottom plate during the centrifugal separation.

In addition, a berm part 133 that prevents sedimentary components from flowing back while the components are easily sedimented through the aperture 131 may protrude in the center of an upper surface of a bottom plate of the aperture 131. In addition, an expansion part that easily discharges the high-density components may be further formed in an upper end of the aperture 131.

The operation of the decanting kit 1 for enabling easy separation and extraction for each component according to the present disclosure having the aforementioned configuration will be described below in detail.

First, the sample contained in a syringe is transferred to the centrifugal separation container 10 so as to separate the sample such as blood or bone marrow collected from patients for each component using the syringe.

More specifically, the sample is injected into the centrifugal separation chamber 14 in the centrifugal separation container body 11 through the injection port 126 formed in the centrifugal separation container cover 12 of the centrifugal separation container 10.

When the sample is injected into the centrifugal separation container body 11, the air staying in the centrifugal separation chamber 14 can be discharged to the outside through the vent port 122 formed in the centrifugal separation container cover 12, thus constantly maintaining the internal pressure of the centrifugal separation container body 11.

Next, as illustrated in FIGS. 8 and 9, after the decanting kit 1 according to the present disclosure is accommodated and mounted in each of the buckets 2-1 hinge-coupled to the rotor 2 of the centrifugal separator 3, the centrifugal separator 3 is driven, and accordingly, the components of the sample contained in the centrifugal separation chamber 14 of the centrifugal separation container body 11 by horizontally rotating the rotor 2 are separated in the order of low density to high density by a centrifugal force.

For instance, for blood, blood cells as the high-density components are concentrated and separated in a lower part of the floater 13, while low-density plasma is concentrated and separated in an upper part of the floater 13, based on the floater 13 in the centrifugal separation chamber 14 of the centrifugal separation container body 11. The floater 13 receives buoyancy from components with different densities and moves in the longitudinal direction.

During the separation of the sample for each component in such a process, the floater 13 moves (i.e., levitates) along the longitudinal direction of the centrifugal separation container body 11 depending on the different densities of each component and is then disposed at the boundary between high-density and low-density components. However, the floater 13 is restricted from moving in the longitudinal direction by the insert cover 15, and the presence of the insert cover 15 can allow the floater 13 to separate only the certain amount of components, thus increasing the separation efficiency.

As described above, the sample of the centrifugal separation container body 11 is centrifugally separated while rotating the rotor 2 according to the operation of the centrifugal separator 3, and when the centrifugal separator 3 stops operating, the centrifugal separation container body 11 operate to get inclined at a predetermined angle along with the bucket 2-1 by a separate angle maintaining means (not shown), thus allowing the components in an upper part of the floater 13 of the centrifugal separation chamber 14 to flow into the decanting container 20. When all the component of the upper part of the floater 13 flow into the decanting container 20, the angle maintaining means recovers the bucket 2-1 to its original state, and the decanting operation is completed.

Next, the components separated from the decanting container 20 of the decanting kit 1 are extracted. In order to extract the separated components, the components are extracted with the syringe through the extraction port 222.

Although embodiments have been described with reference to a number of illustrative embodiments thereof, it will be understood by those skilled in the art that as illustrated in FIG. 8, various changes in form and details may be made therein without departing from the spirit and scope of the invention as defined by the appended claims. Accordingly, the exemplary embodiment disclosed in the present invention and the accompanying drawings are not intended to limit but describe the technical spirit of the present invention, and the scope of the technical spirit of the present invention is not limited by the exemplary embodiment and the accompanying drawings. The scope of the present invention shall be interpreted by the appended claims and it shall be interpreted that all of the technical spirits in the equivalent range are included in the scope of the present invention.

### INDUSTRIAL AVAILABILITY

The present disclosure relates to a decanting kit for enabling easy separation and extraction for each component, and more particular, to a decanting kit for enabling easy separation and extraction for each component, which can facilitate selective extraction of, particularly, stem cells for each component according to a density difference in the separation of blood components using a centrifugal separator, thereby achieving high industrial applicability.

1. A decanting kit for enabling easy separation and extraction for each component, the decanting kit comprising:
a centrifugal separation container configured to concentrate and separate a sample placed therein for each component according to a density difference during centrifugal separation using a centrifugal separator;
a decanting container connected and mounted on an upper part of the centrifugal separation container and configured to decant components separated from the centrifugal separation container while being inclined at a predetermined slope;
a floater provided within the centrifugal separation container, configured to move along the longitudinal direction of the centrifugal separation container, and disposed at a boundary of the centrifugally separated components according to a density difference of the centrifugally separated sample for each component; and
an insert cover mounted within the centrifugal separation container and configured to limit a movement distance of the floater moving along the longitudinal direction of the centrifugal separation container.

2. The decanting kit for enabling easy separation and extraction for each component of claim 1, wherein the centrifugal separation container comprises:
a centrifugal separation container body configured to store the sample targeted for centrifugal separation by a predetermined amount and having a centrifugal separation chamber formed therein to concentrate and separate the sample for each component during the centrifugal separation;
a centrifugal separation container cover configured to seal an upper end of an opening of the centrifugal separation container body and including an injection port configured to inject the sample into the centrifugal separation container, a vent port configured to discharge air during the injection of the sample and a discharge part configured to discharge the centrifugally separated components; and
a first packing ring intervened between the centrifugal separation container body and centrifugal separation container cover and configured to seal the inside;
the centrifugal separation container body comprises:
a flange formed outwards from the upper part of the centrifugal separation container body, to which the centrifugal separation container cover is hooked;
a ring stepped portion formed within the flange and equipped with a first packing ring to seal centrifugal separation container cover and the centrifugal separation container body; and
a coupling groove formed within the ring stepped portion and configured to form the same inner circumferential surface as the inside of the centrifugal separation container cover, and
the centrifugal separation container cover comprises:
a centrifugal separation container cover body provided with a cover side hooked to an outer circumferential surface of the flange;
a ring settling groove formed within the cover side and configured to settle the flange and the first packing ring therein;
a coupling stepped portion inserted into the coupling groove and configured to form the same inner circumferential surface as the centrifugal separation container body;
a discharge part protruding upwards so that the centrifugally separated sample can form a guide surface having the same inner circumferential surface as the centrifugal separation container body during a certain section and be simultaneously decanted to the decanting container.

3. The decanting kit for enabling easy separation and extraction for each component of claim 2, wherein decanting container comprises:
a decanting container body having a decanting chamber formed therein so that the components discharged from the centrifugal separation container are separated, moved and stored; and
a decanting container cover configured to seal an upper end of an opening of the decanting container body and provided with a discharge port and a vent port capable of extracting the components from the decanting container body,
wherein an inlet having the same guide surface as the discharge part so that low-density components discharged from the discharge part of the centrifugal separation container body can flow is formed on one side of the decanting container body,
the discharge part comprises:
an upper flange having a certain shape and extending upwards from the centrifugal separation container cover body by a predetermined distance;
a cover coupling stepped portion extending upwards from the upper flange and having a stepped portion formed therein; and
a discharge part having a certain shape and formed within the cover coupling stepped portion,
the inlet comprises:
an inlet port settled in the cover coupling stepped portion of the discharge part and having the same guide surface as the discharge part; and
a coupling hook having a certain shape, configured to surround an outer side of the cover coupling stepped portion and a second packing ring and hooked to the upper flange, and
a second packing ring intervened between the outer side of the cover coupling stepped portion and the coupling hook and configured to seal the discharge part and the inlet.
